(19) United States
(12) Patent Application Publication
(10) Pub. No.: US 2026/0077743 A1
(43) Pub. Date: Mar. 19, 2026

(54) HOUSING ASSEMBLY WITH REMOVABLE WINDOW FOR AUTONOMOUS VEHICLE SENSORS

(71) Applicant: Torc Robotics, Inc., Blacksburg, VA (US)

(72) Inventors: Nicholas Atanasov, Austin, TX (US); Joseph R. Fox-Rabinovitz, Austin, TX (US)

(21) Appl. No.: 18/885,532

(22) Filed: Sep. 13, 2024

(51) Int. Cl. B60S 1/56; B60S 1/02; B60S 1/52; B60S 1/54

(52) U.S. Cl. CPC B60S 1/56; B60S 1/026; B60S 1/52; B60S 1/54

(57) ABSTRACT

A housing assembly for one or more sensors of an autonomous vehicle. The housing assembly includes a protective cover to encompass the one or more sensors of an autonomous vehicle. The protective cover includes one or more removable window covers that are configured to be removed from the protective cover. The removable window covers may be aligned with the one or more sensors. The housing assembly is configured to be efficiently replacement without impact to the underlying sensors. The housing assembly further includes one or more apparatuses to prevent or remove debris and other buildup that may accumulate on portions of the housing assembly.

### TECHNICAL FIELD

The present disclosure relates generally to the field of protective devices for sensor systems for autonomous vehicles. Specifically, the present disclosure relates to a housing assembly with (i) a protective cover configured to encompass one or more sensors of an autonomous vehicle and (ii) one or more removable window covers to simplify sensor maintenance.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

The perception, localization, behaviors and planning, and control technologies employed by autonomous vehicles rely, at least in part, on data that is collected by numerous sensors and processed by numerous computing systems. The sensors of an autonomous vehicle are susceptible to environmental factors including, but not limited to, dirt, debris, and harsh weather and environmental conditions that can impair the function, lifespan, and reliability of the sensors. In certain cases, the sensors of an autonomous vehicle may be protected by a cover, shield, or similar housing in order to improve the longevity and optimize the functionality of the sensors. However, traditional protective covers for such sensors require extensive disassembly and are often closely embedded to the sensor itself. This arrangement leads to increased maintenance costs and vehicle downtime because any maintenance to the protective cover often requires separate maintenance and recalibration processes for each sensor, as the sensors are often disturbed or otherwise adversely impacted by the maintenance to the adjacent protective cover.

Accordingly, there exists a need for a housing assembly with a protective cover for the sensors of an autonomous vehicle that provides protection for multiple sensors simultaneously, while both (i) enabling maintenance to the cover without disrupting the sensors and (ii) accessing the sensors without excessive disassembly of the cover, thereby providing more efficient maintenance and less vehicle downtime.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to a housing assembly configured to encompass one or more sensors of an autonomous vehicle and provide simplified sensor maintenance procedures.

In one aspect, a housing assembly for one or more autonomous driving sensors mounted to a vehicle. The housing assembly including a protective cover configured to encompass the autonomous driving sensors, one or more openings formed in the protective cover, wherein each of the openings is defined by one or more peripheral edges, one or more window attachment points, wherein at least one of the window attachment points is formed by the peripheral edges of one of the openings and at least one of autonomous driving sensors is aligned with the one opening, and one or more removable window covers that are each attached to one of the window attachment points.

In some aspects, the housing assembly can include housing clearing apparatuses configured to maintain the housing assembly in a clear condition for the autonomous driving sensors to transmit and collect data. In such aspects, the housing clearing apparatuses may include heating elements, wiper assemblies, liquid sprayers, and air jets.

In some aspects, the housing assembly can include a housing monitoring sensor to monitor for soiling, occlusion, or other buildup on the housing assembly. In such aspects, the housing monitoring sensor sends signals to a computing system of the vehicle, which in turn operates the housing clearing apparatuses.

In some aspects, the housing assembly can include a mounting bar, wherein the mounting bar is configured to receive the autonomous driving sensors, wherein the protective cover is configured to removably engage with the mounting bar.

In another aspect, a housing assembly for one or more autonomous driving sensors mounted to a vehicle. The housing assembly including a protective cover configured to encompass the autonomous driving sensors and removably engage with a mounting bar or a mounting point on the vehicle, one or more openings formed in the protective cover, wherein each of the openings is defined by one or more peripheral edges, one or more window attachment points on the protective cover, wherein at least one of the window attachment points is formed by the peripheral edges of one of the openings and at least one of autonomous driving sensors is aligned with the one openings, one or more removable window covers that are each removably attached to one of the window attachment points, and a heating element configured to apply heat to at least one of the one or more removable window covers. In some aspects, the heating element is embedded in the removable window cover.

In some aspects, the housing assembly can include a housing monitoring and clearing assembly. In such aspects, the housing monitoring and clearing assembly includes a housing monitoring sensor and one or more housing clearing apparatuses.

In yet another aspect, a housing assembly for one or more autonomous driving sensors mounted to a vehicle. The housing assembly including a protective cover configured to encompass the autonomous driving sensors and engage with a mounting bar or a mounting point on the vehicle, one or more openings formed in the protective cover, wherein each of the openings is defined by one or more peripheral edges, one or more window attachment points on the protective cover, wherein at least one of the window attachment points is formed by the peripheral edges of one of the openings and at least one of autonomous driving sensors is aligned with the one opening, one or more removable window covers that are each attached to one of the openings on the protective cover, wherein the removable window covers close off the openings, and a heating element configured to apply heat to at least one of the one or more removable window covers, wherein the at least one removable window cover is configured with a connector to enable a detachable connection between the at least one removable window cover and a power supply for the heating element.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

Other features will become apparent from the following detailed description considered in conjunction with the accompanying drawings. It is to be understood, however, that the drawings are designed as an illustration only and not as a definition of the limits of the embodiment of the disclosure.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous vehicle;

FIG. 2 is a block diagram of the autonomous vehicle shown in FIG. 1;

FIG. 3 is a block diagram of an example computing system;

FIG. 4 is a schematic perspective view of a housing assembly mounted over a unified sensor bar of an autonomous vehicle, in accordance with an embodiment of the present disclosure;

FIG. 5 is a schematic perspective view of a housing assembly mounted over sensors of a unified sensor bar on an autonomous vehicle, with a portion of the protective cover being transparent and the removable window covers exploded from the protective cover, in accordance with an embodiment of the present disclosure;

FIG. 6 is a schematic perspective view of a housing assembly and unified sensor bar partially exploded from an autonomous vehicle, in accordance with an embodiment of the present disclosure; and

FIG. 7 is schematic, partially-sectioned end view of a housing assembly mounted over a unified sensor bar, in accordance with an embodiment of the present disclosure.

Corresponding reference numbers or characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, a housing assembly configured to encompass one or more sensors of an autonomous or semi-autonomous vehicle. In an exemplary embodiment, the housing assembly includes a protective cover and one or more removable window covers. In various embodiments, the protective cover is configured to attach to, or otherwise integrate, with a unified sensor bar and encompass one or more sensors that are connected to or positioned on the unified sensor bar. On an autonomous vehicle, a unified sensor bar may be mounted to various portions of the vehicle including, but not limited to, the roof and bumper areas. The unified sensor bar may house or support multiple autonomous driving sensors, with the protective cover being configured to envelop each of the multiple sensors simultaneously and provide comprehensive protection. In some embodiments, the protective cover is shaped to maximize aerodynamic efficiency and complement other aerodynamic features of the autonomous vehicle.

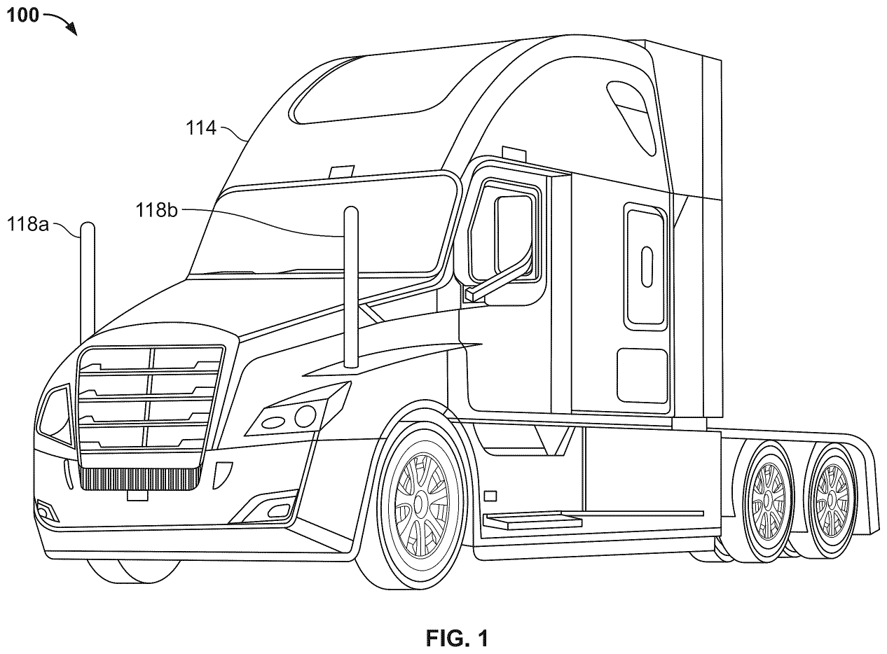

As described herein, the protective cover is designed to enable efficient replacement of the cover without disturbing the sensors, as disturbing a sensor could require recalibration of the sensor. Recalibration of the sensors, in turn, causes increased maintenance time and costs, as well as an increase in vehicle downtime. The protective cover enhances the longevity and optimal functionality of the sensors by serving as either (i) a primary means of protection for a sensor configured without protective housing or (ii) a supplemental means of protection for a sensor already configured with protective housing. Additionally, the protective cover is configured to improve the aerodynamic efficiency of the autonomous vehicle by covering the sensors, which may not have a cohesive aerodynamic design. Various embodiments in the present disclosure are described with reference to FIGS. 1-7 below.

In various embodiments, the protective cover includes one or more removable window covers or similar cover portions that can be fully or partially removed from the main body of the protective cover to provide access to the interior of the protective cover and the sensors contained therein. In some embodiments, the removable window covers may be configured with a heating element to provide defrost and defog capabilities for the removable window covers. In some embodiments, the removable window covers may be treated with a hydrophobic coating. In some embodiments, any portion of the protective cover may be treated with a hydrophobic coating. In some embodiments, the protective cover includes housing clearing apparatuses including, but not limited to, surface wipers, liquid sprayers, and air jets to clear or clean the surface of the protective cover or removable window covers to maintain optimal operating conditions for the sensors covered by the protective cover.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

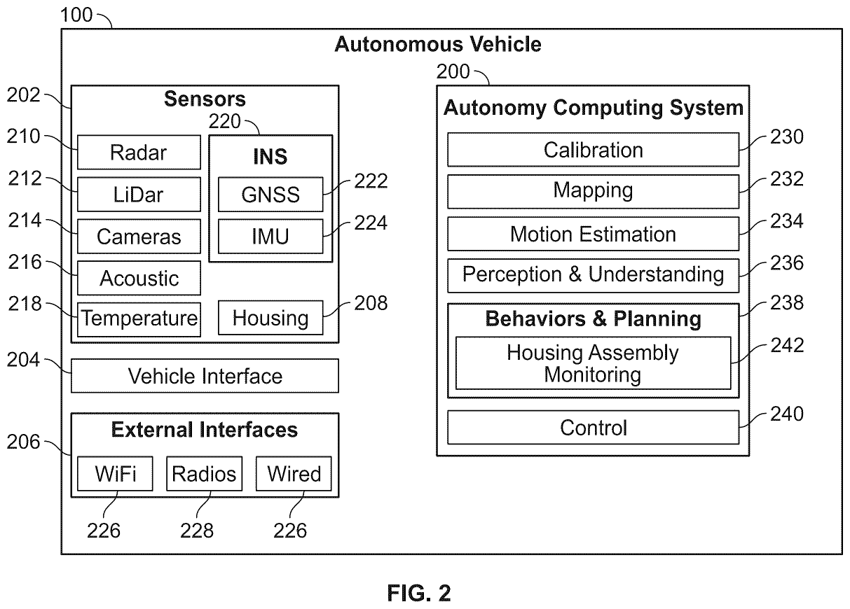

The vehicle 100 may be an autonomous vehicle, in which case the vehicle 100 may omit the steering wheel and the steering column to steer the vehicle 100. Rather, the vehicle 100 may be operated by an autonomy computing system 200 (see FIG. 2) of the vehicle 100 based on data collected by a sensor network including one or more sensors (e.g. sensors 202), which may include one or more sensors 118a, 118b attached to the exterior of the vehicle 100.

FIG. 2 is a block diagram of autonomous vehicle 100 shown in FIG. 1. In the exemplary embodiment, autonomous vehicle 100 includes autonomy computing system 200, sensors 202, a vehicle interface 204, and external interfaces 206.

In the exemplary embodiment, sensors 202 may include various sensors such as, for example, housing sensors 208, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound, microphones, etc.), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a Micro-electrical-mechanical (mems) Device That Measures and Reports One or more features regarding the motion of the autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the exemplary embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the exemplary embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a housing assembly monitoring module 242. The housing assembly monitoring module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The housing assembly monitoring module 242 may perform one or more tasks including, but not limited to, receiving data from the housing sensor 208 related to the accumulation or buildup of a sensing impeding substance, such as condensation, for example, on the housing assembly. The housing assembly monitoring module 242 can use such data to determine when and how to deploy one or more housing clearing apparatuses.

Autonomy computing system 200 of autonomous vehicle 100 may be used in completely autonomous (fully autonomous) or semi-autonomous vehicles. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous”includes both fully autonomous and semi-autonomous.

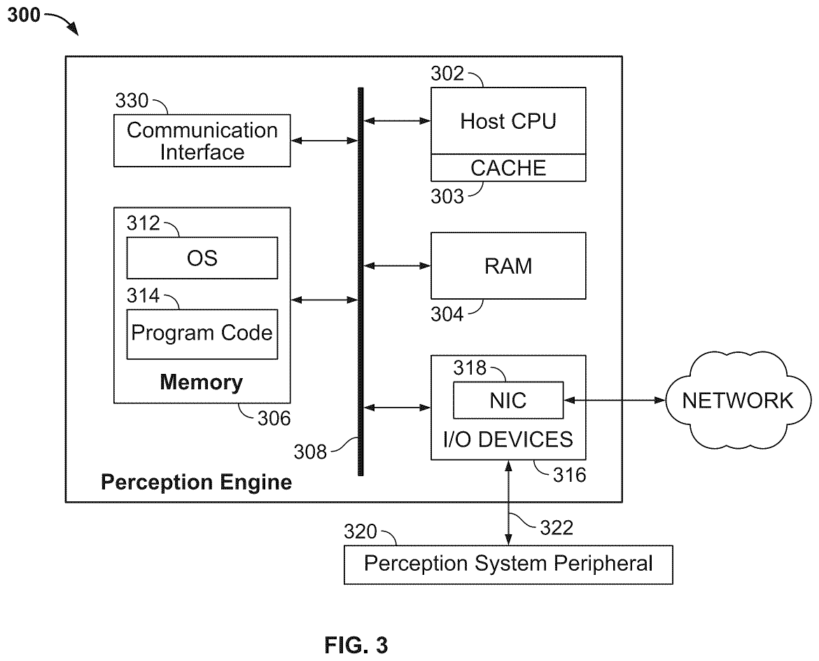

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

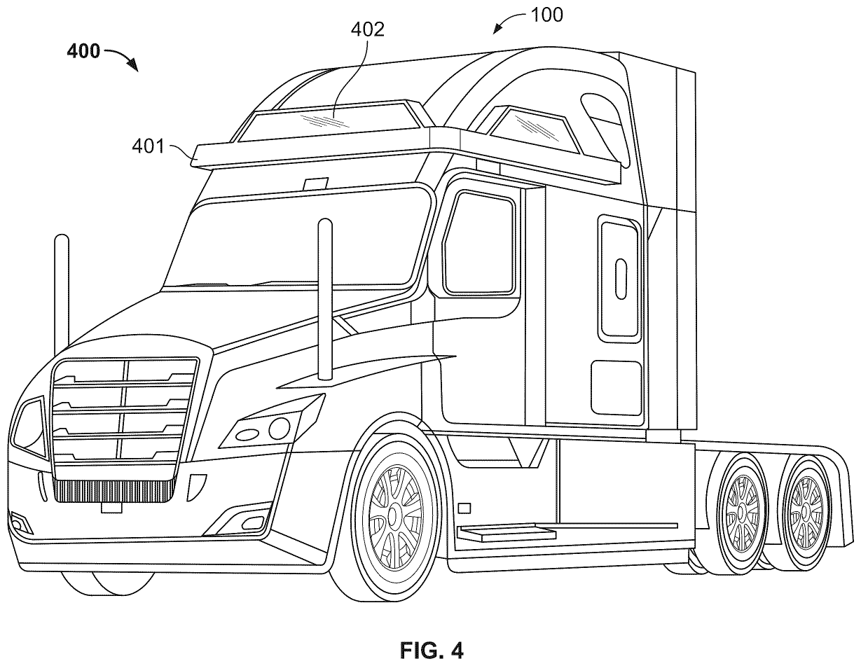

FIG. 4 is a schematic perspective view of a housing assembly mounted over a unified sensor bar of an autonomous vehicle, in accordance with an embodiment of the present disclosure. While in this illustrative example, the housing assembly is mounted to a unified sensor bar on the roof of the autonomous vehicle, the housing assembly may also be configured to mount to unified sensor bars on other portions of the autonomous vehicle including, but not limited to the bumper and side portions of autonomous vehicle. As shown in FIG. 4, the housing assembly 400 includes a protective cover 401 mounted over one or more sensors (not shown, but including at least those sensors 202 described with respect to FIG. 2) that are mounted to a unified sensor bar (not shown) of an autonomous vehicle 100. In at least one exemplary embodiment, the protective cover 401 is configured with one or more removable window covers 402 at window attachment points on surface portions of the protective cover 401. In the exemplary embodiment, a window attachment point may be the edges of an opening formed in surface portions of the protective cover 401.

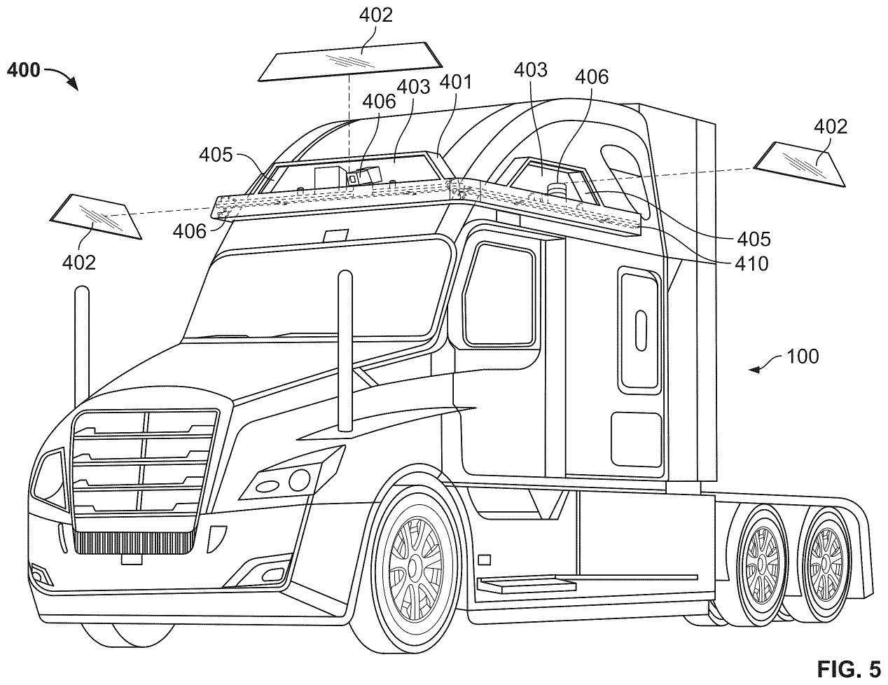

FIG. 5 is a schematic perspective view of a housing assembly mounted over sensors of a unified sensor bar on an autonomous vehicle, with a portion of the protective cover being transparent and the removable window covers shown removed from the protective cover, in accordance with an embodiment of the present disclosure. As shown in FIG. 5, the protective cover 401 is configured to cover one or more sensors 406 of an autonomous vehicle 100. The protective cover 401 may be incorporated with or attached to a mounting bar 410 or similar structural component that is attached to the autonomous vehicle 100. The sensors 406 may be removably attached to the mounting bar 410 or detachably integrated with the protective cover 401 to permit the sensors 406 to be removable from the mounting bar 410 or protective cover 401. In the context of the sensors and the mounting bar or protective cover, as well as other components described as being removably attached or detachably integrated, such an arrangement is characterized by one component capable of being removed, detached, disconnected, separated, uncoupled, or otherwise disengaged from the other component. By configuring the sensors 406 to be removable, maintenance of the sensors 406 is more efficient as the defective sensor can be removed, for repair or replacement, without removing the entire mounting bar 410 or protective cover 401. Correspondingly, a repaired or a new sensor can be attached to the mounting bar 410 or protective cover 401 to replace the defective sensor without removing the entire mounting bar 410 or protective cover 401. In an exemplary embodiment, access to and removable of the sensors 406 may be enabled by the openings 403 in the protective cover 401.

In at least one exemplary embodiment, the protective cover 401 is configured with one or more removable window covers 402 at certain surface portions of the protective cover 401. The removable window covers 402 attach to corresponding window attachment points 405 on the protective cover 401. In an exemplary embodiment, a window attachment point 405 may be the peripheral edges of an opening 403 formed in the protective cover 401. In such exemplary embodiment, at least one of the sensors 406 aligns with the opening 403 having the window attachment point 405, with such opening 403 being covered and closed off when a removable window cover 402 is attached to the window attachment point 405. In some embodiments, multiple sensors may be aligned with the opening 403 having the window attachment point 405, with such opening 403 being covered by a single removable window cover 402. In some embodiments, one or more of the sensors 406 may be mounted within the housing assembly 400 so that the one or more sensors 406 are covered only by the protective cover 401, without being aligned with an opening 403 and without being covered by a removable window cover 402. In another exemplary embodiment, a window attachment point may be formed by (i) one or more holes configured to receive a connector (e.g. screw or bolt) that is attaches the removable window cover 402 to the protective cover 401 or (ii) one or more receptacles configured to receive a corresponding fitting (e.g. prong) formed on the removable window cover 402 (i.e. a snap-fit).

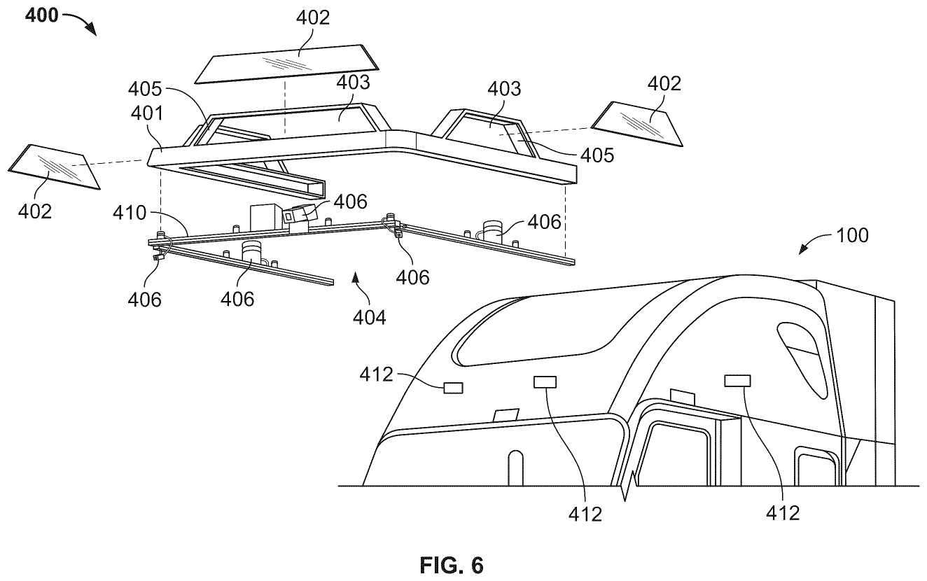

FIG. 6 is a schematic perspective view of a housing assembly and unified sensor bar partially exploded from an autonomous vehicle, in accordance with an embodiment of the present disclosure. As shown in FIG. 6, the housing assembly 400 includes a protective cover 401 that is configured to define a chamber where the one or more sensors 406 are located when such sensors are mounted to, or incorporated within, a unified sensor bar 404 of an autonomous vehicle 100. The unified sensor bar 404 may be coextensive with or attached to a mounting bar 410 or similar structural component that is attached to the autonomous vehicle 100 via one or more mounting points 412. The protective cover 401 can be configured to attach to the mounting bar 410, any of the mounting points 412, or a combination thereof. The protective cover 401 includes one or more removable window covers 402 configured to attach to window attachment points 405 formed in surface portions of the protective cover 401. In an exemplary embodiment, a window attachment point 405 may be formed by the peripheral edges of an opening 403 formed in the protective cover 401. The removable window covers 402 are seated on the window attachment points 405 to thereby close the corresponding openings 403 at the window attachment points 405. The sensors 406 are spaced along the unified sensor bar 404 or mounting bar 410 in a position suitable for the collecting the type of data the particular sensor 406 is designed to collect.

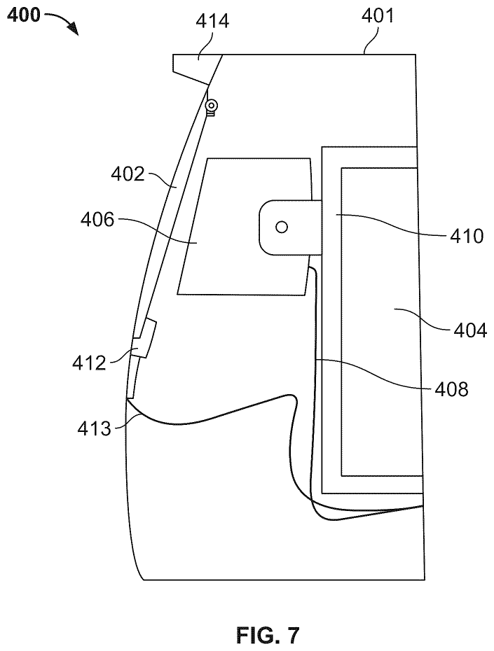

FIG. 7 is a schematic, partially-sectioned end view of a housing assembly mounted over a unified sensor bar, in accordance with an embodiment of the present disclosure. As shown in FIG. 7, the housing assembly 400 includes a protective cover 401 that is configured to encompass a sensor 406 and a mounting bar 410 to which the sensor 406 is mounted. In some embodiments, multiple sensors 406 may be mounted to the mounting bar 410 to form a unified sensor bar 404, with the housing assembly 400 forming a pod-like structure that encompasses the entire unified sensor bar 404. In some embodiments, the housing assembly 400 may form a pod-like structure covering a single sensor 406 mounted to a mounting bar 410. In an exemplary embodiment, the interior of the housing assembly 400 is configured to retain and provide for the management and organization of wiring 408 for the sensors 406.

In an exemplary embodiment, a removable window cover 402 may include a heating element (not shown), for applying, transferring, or otherwise conveying heat to the removable window cover, usable for defrost, defog, snow and ice removable, or alleviating other environmental conditions. In an exemplary embodiment, the heating element may be an embedded copper etched heating element mesh, or similar means, integrated with the removable window cover 402. In some embodiments, the heating element and removable window cover 402 are connected to a power supply 413 by a connector 412 to enable quick detachment of the removable window cover 402 from the protective housing 401. In an exemplary embodiment, the heating element may be integrated with or be a discrete member that is attached to the housing monitoring and clearing assembly 414 or, alternatively, be included as one of the housing clearing apparatuses.

In an exemplary embodiment, the housing assembly 400 may include a housing monitoring and clearing assembly 414 for maintaining portions of the protective cover 401 and removable window covers 402 in a clear and clean condition. Maintaining the protective cover 401 and removable window covers 402 in a clear and clean condition, free of soil, buildup, and other occluding substances, helps to ensure optimal function of the sensors 406. In some embodiments, a housing monitoring and clearing assembly 414 may include a housing monitoring sensor and one or more housing clearing apparatuses. In an exemplary embodiment, the housing monitoring sensor 208, which can be incorporated with the sensors 202 of the autonomous vehicle 100 (See FIG. 2), is configured to detect debris, dirt, water, condensation, contaminants, or any other buildup or potentially obstructive substances accumulating on the housing assembly 400, particularly buildup on a removable window cover 402, that may impact the performance of the sensors 406 covered thereby. Upon detecting unwanted buildup, the housing monitoring sensor can send a signal to the housing assembly monitoring module 242 of the autonomy computing system 200 of the autonomous vehicle 100 and the housing assembly monitoring module 242 can control the activation or deployment of any combination of the one or more of housing clearing apparatuses of the housing monitoring and clearing assembly 414 according to the type of buildup that has been detected by the housing monitoring sensor. Examples of housing clearing apparatuses include, but are not limited to, wiper assemblies, air jet assemblies, liquid sprayer assemblies, and other apparatuses configured to clear or clean a surface. In an exemplary embodiment, the housing monitoring and clearing assembly 414 may be integrated with the aforementioned heating element, at least for the purpose of the housing monitoring sensor monitoring the removable window cover 402 and signaling the autonomy computing system 200 to activate the heating element. In an exemplary embodiment, a housing monitoring and clearing assembly 414 may positioned in proximity to any portion of the housing assembly 400 that may need to be kept clear of buildup to maintain optimal performance of any sensor 406 covered thereby.

In some embodiments, as shown in FIGS. 5 and 6, the removable window covers 402 are entirely detachable from the protective cover 401. The removable window covers 402 may be attached to the protective cover 401 with (i) a snap-fit or similar interlocking connection between a removable window cover 402 and the protective cover 401 or window attachment point 405, (ii) a removable connector, such as a screw or bolt, that secures a removable window cover 402 to a window attachment point 405 in the protective cover 401, (iii) a latch or locking mechanism between each removable window cover 402 and the protective cover 401, or (iv) any other suitable attachment means that would be obvious to one of skill in the art. In some embodiments, the removable window covers 402 may be partially detachable from the protective cover 401. Illustrative examples of a removable window covers 402 partially detachable from the protective cover 401 include, but are not limited to, removable window covers 402 that are attached to the protective cover 401 with a hinge or similar mechanism. In some embodiments, the removable window covers 402 may remain fully attached to the protective cover 401, but otherwise movable relative to each opening 403 formed in the protective cover 401. Illustrative examples of such removable window covers 402 include, but are not limited to, removable window covers 402 that slides over the outer surface of the housing 401 on a track, rail, or similar guided pathway near the corresponding opening 403. The removable window covers 402 are designed to be movable and replaceable to enable efficient replacement of a removable window cover 402, without affecting any sensor 406. The removable window covers 402 are also designed to be movable to enable direct access to the sensors 406 for maintenance of the sensors 406, without further disassembly of the housing assembly 400.

In an exemplary embodiment, the protective cover 401 and removable window covers 402 are constructed from any durable material that may be molded, shaped, or otherwise formed as an enclosure that encompasses one or more sensors of autonomous vehicle. In some embodiments, the protective cover 401 is shaped to complement or enhance other aerodynamic features of the autonomous vehicle. In an exemplary embodiment, the materials selected for the construction of the protective cover 401 and removable window covers 402 are selected based on the type of sensors covered by the protective cover 401 and removable window covers 402. Furthermore, certain portions of the protective cover 401 and different removable window covers 402 may be constructed from different materials for the same reason. Accordingly, each particular sensor can be calibrated according to the materials in the covering portions of the protective cover 401 and removable window covers 402 in proximity to the particular sensor. Furthermore, materials for the protective cover 401 and removable window covers 402 can be selected to complement the signals sent and collected by the sensor. As an illustrative example, the protective cover 401 and removable window covers 402 in proximity to camera-type sensors can be optically transparent so that the camera-type sensor can collect image data. In some embodiments, portions of the housing assembly 400, including both the protective housing 401 and removable window covers, may be treated with a hydrophobic coating. One of ordinary skill in the art would appreciate that there are numerous suitable materials for constructing the protective cover 401 and removable window covers 402 of a housing assembly 400, as well as to complement the operation of the sensors protected thereby, and that embodiments of the present disclosure are contemplated for use with any such materials.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A housing assembly for one or more autonomous driving sensors mounted to a vehicle, the housing assembly comprising:
a protective cover configured to encompass the autonomous driving sensors;
one or more openings formed in the protective cover, wherein each of the openings is defined by one or more peripheral edges;
one or more window attachment points, wherein at least one of the window attachment points is formed by the peripheral edges of one of the openings and at least one of autonomous driving sensors is aligned with the one opening; and
one or more removable window covers that are each attached to one of the window attachment points.

2. The housing assembly of claim 1, further comprising one or more housing clearing apparatuses configured to maintain the housing assembly in a clear condition for the one or more autonomous driving sensors to transmit and collect data.

3. The housing assembly of claim 2, wherein one of the housing clearing apparatuses is a heating element configured to apply heat to one of the one or more removable window covers.

4. The housing assembly of claim 3, wherein the one removable window cover is configured with a connector to enable a detachable connection between the one removable window cover and a power supply for the heating element.

5. The housing assembly of claim 2, wherein one of the housing clearing apparatuses is a wiper assembly, a liquid sprayer, or an air jet.

6. The housing assembly of claim 5, wherein the one housing clearing apparatus is positioned on the protective cover adjacent to one of the one or more window attachment points and is configured to clear a removable window cover attached to the one window attachment point.

7. The housing assembly of claim of claim 1, further comprising a housing monitoring sensor to monitor for buildup on the housing assembly.

8. The housing assembly of claim of claim 7, wherein the housing monitoring sensor is configured to send a signal to a computing system of the vehicle and the computing system is configured to operate one or more housing clearing apparatuses of a housing monitoring and clearing assembly.

9. The housing assembly of claim of claim 1, further comprising a mounting bar, wherein the mounting bar is configured to receive the autonomous driving sensors, wherein the protective cover is configured to removably engage with the mounting bar.

10. The housing assembly of claim of claim 1, wherein the one opening is sized to permit access to and removal any of the one or more autonomous driving sensors that are retained in proximity to the one opening without removing the protective cover from the vehicle.

11. The housing assembly of claim of claim 1, wherein at least one of the one or more removable window covers is treated with a hydrophobic coating.

12. The housing assembly of claim of claim 1, wherein each removable window cover of the removable window covers are made from a material selected based on compatibility with the one or more autonomous driving sensors covered by the removable window cover.

13. The housing assembly of claim of claim 1, wherein each of the one or more autonomous driving sensors are calibrated based on which of the one or more removable window covers is covering the one or more autonomous driving sensors.

14. The housing assembly of claim of claim 1, wherein the protective cover or one of the one or more removable window covers are configured to be replaced without adjusting or recalibrating any of the one or more autonomous driving sensors.

15. A housing assembly for one or more autonomous driving sensors mounted to a vehicle, the housing assembly comprising:
a protective cover configured to encompass the autonomous driving sensors and removably engage with a mounting bar or a mounting point on the vehicle;
one or more openings formed in the protective cover, wherein each of the openings is defined by one or more peripheral edges;
one or more window attachment points on the protective cover, wherein at least one of the window attachment points is formed by the peripheral edges of one of the openings and at least one of autonomous driving sensors is aligned with the one opening;
one or more removable window covers that are each removably attached to one of the window attachment points; and
a heating element configured to apply heat to at least one of the one or more removable window covers.

16. The housing assembly of claim 15, wherein the heating element is embedded in the at least one removable window cover.

17. The housing assembly of claim 16, wherein the at least one removable window cover is configured with a connector to enable a detachable connection between the at least one removable window cover and a power supply for the heating element.

18. The housing assembly of claim 16, wherein the heating element is an embedded copper etched mesh.

19. The housing assembly of claim 15, further comprising a housing monitoring and clearing assembly, wherein the housing monitoring and clearing assembly includes a housing monitoring sensor and one or more housing clearing apparatuses.

20. A housing assembly for one or more autonomous driving sensors mounted to a vehicle, comprising:
a protective cover configured to encompass the autonomous driving sensors and engage with a mounting bar or a mounting point on the vehicle;
one or more openings formed in the protective cover, wherein each of the openings is defined by one or more peripheral edges;
one or more window attachment points on the protective cover, wherein at least one of the window attachment points is formed by the peripheral edges of one of the openings and at least one of autonomous driving sensors is aligned with the one opening;
one or more removable window covers that are each attached to one of the openings on the protective cover, wherein the removable window covers close off the openings; and
a heating element configured to apply heat to at least one of the one or more removable window covers, wherein the at least one removable window cover is configured with a connector to enable a detachable connection between the at least one removable window cover and a power supply for the heating element.
